(19) United States
(12) Patent Application Publication
(10) Pub. No.: US 2022/0069498 A1
(43) Pub. Date: Mar. 3, 2022

(54) CONNECTOR TERMINAL MATERIAL AND TERMINAL FOR CONNECTOR

(71) Applicant: MITSUBISHI MATERIALS CORPORATION, Tokyo (JP)

(72) Inventors: Yoshie Tarutani, Naka-shi (JP); Kiyotaka Nakaya, Naka-shi (JP)

(73) Assignee: MITSUBISHI MATERIALS CORPORATION, Tokyo (JP)

(21) Appl. No.: 17/422,478

(22) PCT Filed: Jan. 24, 2020
(86) PCT No.: PCT/JP2020/002088

§ 371 Date: Jul. 13, 2021

(30) Foreign Application Priority Data
Jan. 24, 2019 (JP) 2019-010102

(51) Int. Cl. H01R 13/03; H01R 43/16

(52) U.S. Cl. CPC H01R 13/03; H01R 2201/26; H01R 43/16

(57) ABSTRACT

To provide a method of manufacturing a connector terminal material and a terminal for a connector to improve wear resistance and heat resistance. A connector terminal material of the present invention is provided with a base material in which at least a surface layer is made of copper or copper alloy and a silver-nickel alloy layer covering at least a part of a surface of the base material and having a film thickness of 0.5 μm or more and 50 μm or less; and nickel content of the silver-nickel alloy layer is 0.05 at % or more and 2.0 at % or less. Between the base material and the silver-nickel alloy layer, a nickel layer made of nickel or nickel alloy is provided; and a film thickness of the nickel layer is preferably 0.5 μm or more and 5 μm or less.

### BACKGROUND OF THE INVENTION

### Technical Field

The present invention relates to a connector terminal material and a terminal for a connector provided with a useful film used for electric wiring connection in an automobile, consumer equipment, or the like in which fine sliding occurs. Priority is claimed on Japanese Patent Application No. 2019-010102 filed Jan. 24, 2019, the content of which is incorporated herein by reference.

### Background Art

Conventionally, an on-vehicle connector used for connecting electric wiring of an automobile or the like is known. The terminal pair used for the on-vehicle connector (on vehicle terminal) is designed to be electrically connected by bringing a contact piece provided in a female terminal into contact with a male terminal inserted into the female terminal with a predetermined contact pressure.

As such a connector (terminal), a terminal with tin plating in which tin plating treatment and reflow treatment are performed on a copper or copper alloy plate was generally used in many cases. However, in recent years, accompanied with the high current and the high voltage of the automobile, the use of a terminal in which noble metal plating to which more current can be flow and has excellent heat resistance and wear resistance are performed increases.

As an on-vehicle terminal for which such heat resistance and wear resistance are required, for example, a silver-plating terminal for a connector described in Patent Document 1 is known. In the silver terminal for the connector, a surface of a base material made of copper or copper alloy is coated with a silver-plating layer. The silver-plating layer has a first silver-plating layer located on the lower layer side (base material side) and a second-silver plating layer located on the upper layer side of the first silver-plating layer; and the crystal grain size of the first silver-plating layer is formed larger than the crystal grain size of the second silver-plating layer.

That is, in the configuration of Patent Document 1, by forming the crystal grain size of the first silver-plating layer larger than the crystal grain size of the second silver-plating layer, the Cu component is prevented from diffusing from the base material to the second silver-plating layer.

Patent Document 2 discloses a member in which an intermediate layer made of silver or silver alloy having an antimony concentration of 0.1 mass % or less is formed on at least a part of a surface of a base material of copper or copper alloy, and a silver alloy layer (outermost layer) having a Vickers hardness HV140 or more is formed on the intermediate layer. A base layer of nickel or nickel alloy is formed between the base material and the intermediate layer.

That is, in the configuration of Patent Document 2, hardness is increased by adding antimony to the intermediate layer of silver or silver alloy, thereby improving the wear resistance of the base material of copper or copper alloy.

### CITATION LIST

### Patent Document

Patent Document 1: Japanese Unexamined Patent Application, First Publication No. 2008-169408

Patent Document 2: Japanese Unexamined Patent Application, First Publication No. 2009-79250

### SUMMARY OF INVENTION

### Technical Problem

However, in the configuration of Patent Document 1, since the crystal grain size of silver increases by heating and the hardness of the silver-plating layer coating the surface of the base material is deteriorated, the wear resistance is deteriorated under high temperature environment. In order to compensate the reduction in the wear resistance, it is possible to increase the film thickness of the silver-plating layer; but there is a problem in cost.

On the other, in the configuration of Patent Document 2, antimony contained in the intermediate layer is concentrated on the surface of the outermost layer by heating, and then oxidized and to increase the contact resistance. When the base layer made of nickel or nickel alloy is used, nickel oxide is generated between the base layer (nickel or nickel alloy) and the intermediate layer (silver or silver alloy) by heating, which causes the nickel oxide to cause peeling of the intermediate layer.

The present invention is achieved in consideration of the above circumstances, and has an object to provide a connector terminal material and a terminal for a connector capable of improving wear resistance and heat resistance.

### Solution to Problem

A connector terminal material of the present invention is provided with a base material in which at least a surface layer is made of copper or copper alloy, and a silver-nickel alloy layer having a film thickness of not less than 0.5 μm and not more than 50 μm and a nickel content of not less than 0.05 at % and not more than 2.0 at %, covering at least a part of a surface of the base material.

In present invention, since the silver-nickel alloy layer formed on the outermost surface of the base material contains nickel, the hardness of the outermost surface of the base material can be increased and the wear resistance can be improved. Since no intermetallic compound is formed between silver and nickel, the hardness of the silver-nickel alloy layer can be prevented from becoming too high. Since nickel has higher melting point than antimony, the heat resistance can be improved, and a lowering of the hardness by heating can be suppressed.

Since the atomic radius difference between silver and nickel is larger than the atomic radius difference between silver and antimony, the nickel content in silver-nickel alloy layer is not less than 0.05 at % and not more than 2.0 at % so that silver and nickel are slightly eutectic, and the hardness can be reliably increased.

If the nickel content in the silver-nickel alloy layer is less than 0.05 at %, the heat resistance and the wear resistance are deteriorated; and if it exceeds 2.0 at %, the silver-nickel alloy layer is too hard to cause cracking due to press working or the like. Moreover, the contact resistance is also increased.

When the connector terminal material is used as a terminal for a connector, the surface of the contact portion of the terminal is the silver-nickel alloy layer, thereby suppressing the occurrence of adhesive wear and improving wear resistance.

If the film thickness of the silver-nickel alloy layer is less than 0.5 μm, the heat resistance and the wear resistance cannot be improved; and if it excesses 50 μm, the silver-nickel alloy layer is too thick and cracks occur by press machining or the like.

For a preferable aspect of the connector terminal material of the present invention, the connector terminal material further includes a nickel layer provided between the base material and the silver-nickel alloy layer, made of nickel or nickel alloy, and having a thickness of not less than 0.5 μm and not more than 5.0 μm.

In the above-described aspect, since the silver-nickel alloy layer is formed on the nickel layer, peeling of the silver-nickel alloy layer from the base material can be suppressed. If the film thickness of the nickel layer is less than 0.5 μm, Cu component is diffused from the base material made of copper or copper alloy into the silver-nickel alloy layer under a high-s temperature environment and a resistance value of the silver-nickel alloy layer increases, so that the heat resistance may be deteriorated. On the other, if the film thickness of the nickel layer excesses 5 μm, there is a possibility of occurring cracks when the press machining or the like is carried out.

A terminal for a connector of the present invention is a terminal for a connector formed from the above-described connector terminal material in which the silver-nickel alloy layer is arranged at a surface of a contact portion.

### Advantageous Effects of Invention

According to the present invention, wear resistance and heat resistance of a connector terminal material and a terminal for a connector can be improved.

### BRIEF DESCRIPTION OF DRAWINGS

FIG. 1 It is a cross sectional view schematically showing a connector terminal material according to an embodiment of the present invention.

FIG. 2 is a SIM (Scanning Ion Microscope) image of a cross section of a connector terminal material before heating in Example.

### DESCRIPTION OF EMBODIMENTS

An embodiment of the present invention will be explained using drawings below.

[Constitution of Connector Terminal Material]

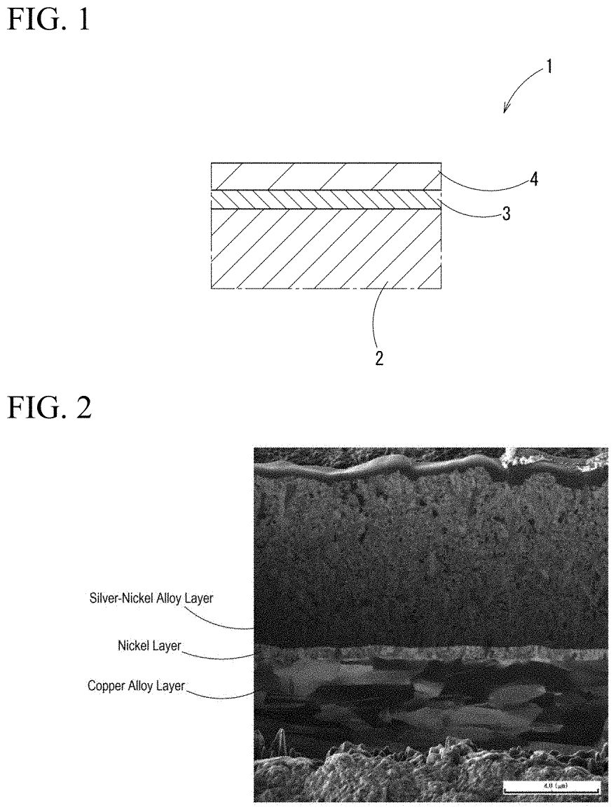

A connector terminal material 1 of the present embodiment is provided with a plate-like base material 2 in which at least a surface layer is made of copper or copper alloy, a nickel layer 3 made of nickel or nickel alloy covering an entire upper surface of the base material 2, and a silver-nickel alloy layer 4 covering an entire upper surface of the nickel layer 3, as shown schematically in the cross section in FIG. 1. The base material 2 is not particularly limited in the composition if the surface layer is made of copper or copper alloy.

In this embodiment, as shown in FIG. 1, the base material 2 is composed of a plate material made of copper or copper alloy, however, it may be composed of a plating material subjected to a copper plating treatment or a copper alloy treatment on a surface of a mother material. In this case, as the mother material, a metal such as oxygen-free copper (C10200) or Cu—Mg based copper alloy (C18665) or the like can be applied.

The nickel layer 3 is formed by applying nickel or nickel alloy plating on the base material 2. The nickel layer 3 has a function of suppressing diffusion of Cu component in the base material 2 to the silver-nickel alloy layer 4 covering the nickel layer 3. A thickness (film thickness) of the nickel layer 3 is preferably 0.5 μm or more and 5 μm or less; more preferably 0.5 μm or more and 2 μm or less.

If the thickness of the nickel layer 3 is less than 0.5 μm, Cu component is diffused from the base material 2 made of copper or copper alloy into the silver-nickel alloy layer 4 in the high temperature environment, so that the contact resistance value of the silver-nickel alloy layer 4 increases and there is a possibility of decreasing of the heat resistance. On the other, if the thickness of the nickel layer 3 exceeds 5 μm, there is a possibility of occurrence of cracks when bending machining or the like is carried out. The composition of the nickel layer 3 is not particularly limited if the nickel layer 3 is made of nickel or nickel alloy.

The silver-nickel alloy layer 4 is formed by carrying out a silver-strike plating treatment on the nickel layer 3 and then carrying out a silver-nickel alloy plating treatment on its upper surface. The silver-nickel alloy layer 4 is formed on the nickel layer 3 as the outermost surface of the 1. The silver-nickel alloy layer 4 is composed of alloy of silver and nickel. Since intermetallic compound is not formed between silver and nickel, the hardness of the outermost surface of the 1 is suppressed to be too high.

The nickel content of the silver-nickel alloy layer 4 is not less than 0.05 at % and not more than 2.0 at %; more preferably, 0.1 at % or more and 1.0 at % or less. In the silver-nickel alloy layer 4, if the nickel content is less than 0.05 at %, the wear resistance is decreased since the hardness of the silver-nickel alloy layer 4 is decreased; and if the nickel content exceeds 2.0 at %, the silver-nickel alloy layer 4 becomes too hard and cracks may occur by press machining or the like.

Since the electric conductivity is worse in nickel than silver, the contact resistance of the silver-nickel alloy layer 4 becomes high if the nickel content exceeds 2.0 at %. Containing the above-described range of nickel, the hardness is increased and the wear resistance is improved in the silver-nickel alloy layer 4. Specifically, the Vickers hardness of the silver-nickel alloy layer 4 is in the range of 150 HV to 250 HV.

The film thickness of the silver-nickel alloy layer 4 is set to 0.5 μm or more and 50 μm or less; more preferably, 1 μm or more and 10 μm or less. In the silver-nickel alloy layer 4, if the film thickness is less than 0.5 μm, the heat resistance and the wear resistance cannot be improved; and if the film thickness exceeds 50 μm, the silver-nickel alloy layer 4 is too thick and cracks occur by press machining or the like.

Next, a manufacturing method of the 1 will be explained. The manufacturing method of the 1 includes: a pretreatment step cleaning a plate material to be the base material 2 in which at least a surface is made of copper or copper alloy; a nickel layer forming step forming the nickel layer 3 on the base material 2; a silver strike plating step forming a silver-strike plating layer by applying a silver-strike plating treatment on the nickel layer 3; and a silver-nickel alloy layer forming step forming a silver-nickel alloy layer by applying the silver-nickel alloy plating treatment on the silver-strike plating layer.

[Pretreatment Step]

First, preparing a plate material at least a surface is made of copper or copper alloy is prepared as the base material 2, and the pretreatment to clean the surface by degreasing, pickling and the like is carried out.

[Nickel Layer Forming Step]

At least a part of the surface of the base material 2 is subjected to a nickel-plating treatment or a nickel alloy treatment to form the nickel layer 3 on the base material 2. The nickel layer 3 is formed by, for example, using a nickel-plating bath composed of nickel sulfamate 300 g/L, nickel chloride 30 g/L and boric acid 30g/L, and applying a nickel-plating treatment under a condition at a bath temperature 45° C. and current density 3 A/dm².

The nickel-plating treatment forming the nickel layer 3 is not particularly limited as long as a dense film can be obtained to have nickel as main constitute; it may be formed by electroplating using a known Watt bath. When the silver-nickel alloy layer 4 is formed directly on the surface of the base material 2, the nickel layer forming step is not carried out.

[Step of Silver Strike Plating]

Activation treatment is carried out on the nickel layer 3 using an aqueous potassium hydroxide solution of 5 to 10 mass %; then the silver-strike plating treatment is carried out on the nickel layer 3 to form the silver-strike plating layer. The silver-strike plating treatment is performed to improve the adhesion between the silver-nickel alloy layer 4 formed on the nickel layer 3 and the nickel layer 3.

The composition of a plating bath for subjecting the silver-strike plating treatment is not particularly limited; for example, it consists of silver cyanide (AgCN) 1 g/L to 5 g/L and potassium cyanide (KCN) 80 g/L to 120 g/L. Using stainless steel (SUS316) as an anode in the silver-plating bath, by carrying out the silver-plating treatment under a condition of a bath temperature 25° C. and a current density 1 A/dm² for about 30 seconds to form the silver-strike plating layer.

[Step of Forming Silver-Nickel Alloy Layer]

Silver-nickel alloy plating treatment is applied to the silver-strike plating layer to form the silver-nickel alloy layer 4. The composition of a plating bath for forming the silver-nickel alloy layer 4, for example, consists of silver cyanide (AgCN) 30 g/L to 50 g/L, potassium cyanide (KCN) 100 g/L to 150 g/L, potassium carbonate (K₂CO₃) 15 g/L to 40 g/L, Potassium tetracyanonickelate (II) monohydrate (K₂[Ni(CN)₄].H₂O) 80 g/L to 150 g/L, and an additive for depositing the silver-plating layer smoothly. The additive can be a general additive, as long as it does not contain antimony.

Using a pure silver plate as an anode in the silver-plating bath and applying the silver-nickel alloy plating treatment under a condition of a bath temperature 25° C., current density 4 A/dm² to 10 A/dm² for about 0.1 minute to 23 minutes, the silver-nickel alloy layer 4 having a film thickness of 0.5 μm or more and 50 μm or less is formed.

If the current density is less than 4 A/dm², the eutectoid of nickel is prevented; and if the current density is more than 15 A/dm², the appearance of the silver-nickel alloy layer 4 is impaired. A plating bath for forming the silver-nickel alloy layer 4 is a cyan bath and not particularly limited in the composition thereof, as long as antimony is not contained in an additive.

As described above, the 1 in which the nickel layer 3 and the silver-nickel alloy layer 4 are formed on the surface of the base material 2 is formed. Furthermore, carrying out the press machining and the like on the 1, a terminal for a connector in which the silver-nickel alloy layer 4 is arranged at a contact portion is formed.

In the 1 of the present embodiment, since the silver-nickel alloy layer 4 formed on the outermost surface of the base material 2 contains nickel, the hardness of the outermost surface of the base material 2 is increased and the wear resistance can be improved. Since intermetallic compound is not generated between silver and nickel, the hardness of the outermost surface of the base material 2 can be suppressed to be too high. Since nickel is higher in melting point than antimony, the heat resistance can be improved and deterioration of hardness can be suppressed.

Since the atomic radius difference between the silver and nickel is larger than the atomic radius difference between silver and antimony, the hardness can be reliably increased by only making the nickel content in the silver-nickel alloy layer 4 to be 0.05 at % or more and 2.0 at % or less to make the nickel eutectoid. Since the silver-nickel alloy layer 4 is formed on the nickel layer 3, the peeling of the silver-nickel alloy layer 4 from the base material can be suppressed.

Other details are not limited to the construction of the embodiment, and various modification may be made without departing from the scope of the present invention. For example, in the above embodiment, the nickel layer 3 is provided between the base material 2 and the nickel layer 3, but the nickel layer 3 may not be included. That is, the silver-nickel alloy layer 4 may be formed directly on the base material 2; in this case, it is not always necessary to carry out the step of forming the nickel layer.

In the above-described embodiment, the nickel layer 3 and the silver-nickel alloy layer 4 are formed on the entire surface of the base material 2; however, it is not limited to this, for example, the nickel layer 3 and the silver-nickel alloy layer 4 may be formed on a part of the upper surface of the base material 2, or the silver-nickel alloy layer 4 may be formed on a part of an upper surface of the nickel layer 3.

### EXAMPLE

### First Experimental Example

Samples of Examples 1 to 5 and Comparative Examples 1 to 5 were made by the following method. For Examples 1 to 5, a base material made of a copper alloy plate having a thickness of 0.3 mm was prepared, and by degreasing, pickling and the like, the surface was cleaned (the step of pretreatment). Thereafter, the nickel-plating treatment was applied on a part of the surface of the base material (the step of forming the nickel layer), and the nickel layer having the thickness shown in Table 1 was formed on the base material.

Then, an activation treatment cleaning the surface of the nickel layer was carried out using aqueous potassium hydroxide solution with 5 mass %. After the activation treatment, the base material coated by the nickel layer was subjected to the silver-strike plating treatment (the step of silver-strike plating) to form the silver-strike plating layer.

Forming the silver-nickel alloy layer by applying the silver-nickel alloy plating treatment on the silver-strike plating layer by adjusting the plating time to obtain the silver-nickel alloy plating layer having the film thickness shown in Table 1 (the step of forming the silver-nickel alloy layer), and the samples of Examples 1 to 5 were obtained. The conditions for plating were as follows.

<Nickel Plating Treatment Condition>

### Plating Bath Composition

Nickel sulfamate 300 g/L

Nickel chloride 30 g/L

Boric acid 30 g/L

Bath temperature 45° C.
Current density 3 A/dm²

<Silver-strike Plating Treatment Condition>

### Plating Bath Composition

Silver cyanide 2 g/L

Potassium cyanide 100 g/L

### Anode

SUS316

Bath temperature 25° C.
Current density 1 A/dm²

<Silver-Nickel Alloy Plating Treatment Condition>

### Plating Bath Composition

Silver cyanide 35 g/L

Potassium cyanide 120 g/L

Potassium carbonate 35 g/L

Potassium tetracyanonickelate (II) monohydrate 130 g/L

Additive 5 ml/L

### Anode

Pure silver plate

Bath temperature 25° C.

For Comparative Examples 1 to 3, samples having the nickel layer and the silver-nickel alloy layer having the film thickness shown in Table 1 were formed by the same method as in the above-described Examples 1 to 5.

For Comparative Example 4, after applying the nickel-plating treatment and the silver-strike plating treatment on the surface of the base material as in Examples 1 to 5, the silver-nickel alloy plating was not carried out, but glossy silver-plating treatment was performed. The glossy silver-plating treatment was performed using a plating bath containing antimony (AgCN: 55 g/L, NaCN: 120 g/L, Na₂CO₃: 15 g/L, Nissin bright N (made by Nissin Kasei CO., Ltd.): 40 ml/L), at bath temperature 25° C., current density 1 A/dm² and using a pure silver plate as an anode; and a silver-alloy layer (AgSb layer) was formed to obtain a sample.

For Comparative Example 5, after applying the nickel-plating treatment and the silver-strike plating treatment on the surface of the base material as in Examples 1 to 5, the silver-nickel alloy plating treatment was not performed, but a silver-plating treatment was performed to obtain a sample. The silver-plating treatment was performed using a plating bath of silver cyanide 40 g/L, potassium cyanide 120 g/L, potassium carbonate 15 g/L, and additive AgO-56 (made by Atotech Japan K.K.) 4 ml/L, under a condition at bath temperature 25° C. and current density 1 A/dm², and using a pure silver plate as an anode; and a silver layer having a film thickness 3 μm was formed. That is to say, in the sample of Comparative Example 5, the outermost surface was formed from the silver layer.

Various evaluations were performed for each sample of Examples 1 to 5 and Comparative Examples 1 to 5.

[Measurement of Film Thickness (μm) of Nickel Layer and Silver-nickel Alloy Layer]

For each film thickness of the nickel layer and the silver-nickel alloy layer, performing cross section processing using a focus ion beam apparatus FIB (model No.: SMI 3050TB) made by Seiko Instruments Inc., and measuring the film thickness of any three portions in a cross-section SIM (Scanning Ion Microscopy) image at an inclination angle of 60° , the average thereof was obtained and then converted to an actual length.

[Measurement of Nickel Content (at %)]

For the nickel content in the silver-nickel alloy layer, using an electron beam microanalyzer EPMA (model No. DCA-8530F) made by JEOL Ltd., measuring any three portions of a surface of each sample at an acceleration voltage 10 kV and a beam diameter 30 μm, the average was obtained.

[Vickers Hardness (before and after heating)]

Before and after heating each sample at 150° C. for 240 hours, using a micro-Vickers hardness tester HM minus 200 (made by Mitutoyo Corporation), Vickers hardness was measured 10 times in a condition of a load 0.005 N and the average thereof was obtained.

[Hardness Reduction]

Hardness reduction was calculated by subtracting the value of Vickers hardness after heating at 150° C. from the value of Vickers hardness before heating obtained by the above-described measurement of Vickers hardness.

[Contact Resistance (mΩ)]

From each sample before and after the heating, a flat plate of 60 mm×10 mm was cut out to form a substitute test piece of the male terminal; and the same plate was subjected to emboss processing of radius of curvature 1.0 mm to form a substitute test piece of a female terminal. Using abrasion wearing test equipment (UMT-Tribolab) made by Bruker AXS Inc., the convex surface of the female terminal test piece was brought into contact with the male terminal test piece horizontally disposed, and the contact resistance value was measured when applying a load 0 N to 2 N with a load-apply speed of 1/15 N/sec on the male terminal test piece.

[Heat Resistant Peeling]

For a heat resistant peeling test, a test was carried out by the cross-cut test described in JIS (Japanese Industrial Standard) K5600-5-6 after heating at 175° C. for 1000 hours in an atmosphere heating furnace; ones in which the film was not peeled was “A”, and ones in which one or more square was peeled was “B”.

TABLE 1

| | | | | | Silver-Nickel |
|---|---|---|---|---|---|
| | | Nickel | | | Alloy |
| | | Layer | Silver-Nickel Alloy Layer | | Plating |
| | | Film | Film | | Treatment |
| | | Thick- | Thick- | Nickel | Current |
| | | ness | ness | Content | Density |
| | No. | [μm] | [μm] | [at. %] | [A/dm²] |
| Example | 1 | 3.0 | 0.5 | 0.8 | 7 |
| | 2 | 3.0 | 3.0 | 1.6 | 10 |
| | 3 | 1.0 | 5.0 | 0.5 | 6 |
| | 4 | 1.0 | 10.0 | 1.2 | 9 |
| | 5 | 0.5 | 20.0 | 0.4 | 4 |
| Compara- | 1 | 0.5 | 0.2 | 1.3 | 11 |
| tive | 2 | 3.0 | 1.0 | 2.5 | 16 |
| Example | 3 | 1.0 | 5.0 | 0.01 | 2 |
| | 4 | 3.0 | — | — | — |
| | 5 | 3.0 | — | — | — |

TABLE 2

| | | Vickers Hardness | | | Contact Resistance | | |
|---|---|---|---|---|---|---|---|
| | | [HV] | | | [mΩ] | | Heat |
| | | Before | After | Reduc- | Before | After | Resistant |
| No. | | Heating | Heating | tion | Heating | Heating | Peeling |
| Example | 1 | 231 | 219 | 12 | 0.7 | 1.9 | A |
| | 2 | 244 | 231 | 13 | 0.5 | 1.2 | A |
| | 3 | 220 | 218 | 2 | 0.4 | 0.6 | A |
| | 4 | 241 | 225 | 16 | 0.5 | 0.6 | A |
| | 5 | 215 | 208 | 7 | 0.3 | 0.5 | A |
| Compar- | 1 | 231 | 212 | 19 | 0.9 | 2.5 | A |
| ative | 2 | 248 | 236 | 12 | 0.6 | 3.4 | A |
| Example | 3 | 112 | 90 | 22 | 0.3 | 0.40 | B |
| | 4 | 195 | 141 | 54 | 0.8 | >20 | B |
| | 5 | 109 | 75 | 34 | 0.2 | 0.30 | B |

As shown in Table 1 and Table 2, in Examples 1 to 5, the film thickness of the silver-nickel alloy layer formed on the outermost surface of the base material was 0.5 μm or more and 50 μm or less, and the nickel content of the silver-nickel alloy layer was 0.05 at % or more and 2 at % or less. Accordingly, the Vickers hardness before heating was 215 HV or more, the reduction after heating was small as 16 HV or less, and the Vickers hardness after heating was 208 HV or more: it was shown that the wear resistance was high in Examples 1 to 5.

In Examples 1 to 5, the contact resistance value was 1.9 mΩ or less at most in any case of before or after heating: the heat resistance was shown to be high. Moreover, in Examples 1 to 5, the result of the heat resistant peeling test was “A”: the silver-nickel alloy layer was not peeled off from the nickel layer.

FIG. 2 is an SIM image of the sample of Example 3 before heating and it is known that the silver-nickel alloy layer is formed on the nickel layer on the base material (copper alloy layer).

In Comparative Example 1, since the film thickness of the silver-nickel alloy layer was small as 0.2 μm, the contact resistance value after heating was 2.5 mΩ; it was shown that the heat resistance was low. In Comparative Example 2, since the nickel content in the silver-nickel alloy layer was high as 2.5 at %, the contact resistance value after heating was 3.4 mΩ; it was shown that the heat resistance value was low.

In Comparative Example 3, since the nickel content in the silver-nickel alloy layer was high as 0.01 at %, the Vickers hardness before heating was low as 112 HV, the hardness reduction after heating was large as 22 HV, and the evaluation of the heat resistant peeling test was “B”: it was shown that the wear resistance and the anti-peeling property were low.

In Comparative Example 4, the outermost layer is configured by a silver alloy layer (AgSb) containing antimony since the glossy silver-plating treatment using the plating bath in which antimony was added was carried out, the hardness reduction after heating was large as 54 HV even though the Vickers hardness before heating was high as 195 HV, the contact resistance after heating exceeded 20 mn, and the result of the heat-resistance peeling test was also “B: it is shown that the wear resistance, the heat resistance and the anti-peeling property were low.

In Comparative Example 5 in which the silver plating treatment was carried out at last, since the outermost layer is configured of the silver layer, each Vickers hardness before and after heating was 109 HV or less, the hardness reduction was large as 34 HV, and the result of the heat resistant peeling test was “B”, it is shown that the wear resistance and the anti-peeling property were low.

### Second Experimental Example

Samples of Examples 6 to 8 and Comparative Examples 6 to 8 were made by the following method. For Examples 6 to 8, a base material made of a copper alloy plate having a thickness of 0.3 mm was prepared; by degreasing, pickling and the like, the surface was cleaned (the step of pretreatment); then the silver-strike plating treatment was performed on a part of the surface of the base material (the step of silver-strike plating), so the silver-strike plating layer was formed.

Then, performing the silver-nickel alloy plating treatment on the silver-strike plating layer with adjusting the plating time to obtain the film thickness of the silver-nickel alloy layer in Table 3 (the step of the silver-nickel alloy layer) to form the silver-nickel alloy layer and the samples of Examples 6 to 8 were made. That is, in the samples of Examples 6 to 8, the silver-nickel alloy layer was formed directly on the base material. In addition, the same ones as in the above-described first experiment were used for composition and the like of the silver-strike plating bath and the silver-nickel alloy plating bath.

For Comparative Example 6, after performing the silver-strike plating treatment on the surface of the base material as in the above-described Examples 6 to 8 (the step of silver-strike plating), the silver-nickel alloy plating treatment was applied with adjusting the plating time to have the film thickness of the silver-nickel alloy layer in Table 3 (the step of forming the silver-nickel alloy layer) to form the silver-nickel alloy layer.

For Comparative Example 7, after applying the silver-strike plating treatment on the surface of the base material as in Examples 6 to 8 and Comparative Example 6, the silver-nickel alloy plating treatment was not carried out, but the glossy silver-plating treatment was performed to form a silver alloy layer (AgSb layer), and the sample of Comparative Example 6 was obtained. For the glossy silver-plating treatment, a plating bath containing antimony (AgCN: 55 g/L, NaCN: 120 g/L, Na₂CO₃: 15 g/L, Nissin bright N (made by Nissin Kasei CO., Ltd.): 40 ml/L) was used at bath temperature 25° C. and current density 1 A/dm² using a pure silver plate as an anode.

For Comparative Example 8, after applying the silver-strike plating treatment on the surface of the base material as in Examples 6 to 8 and Comparative Examples 6 and 7, the silver-nickel alloy plating treatment was not performed, but the silver-plating treatment was performed to form a silver layer having a film thickness of 3 μm. The silver-plating treatment was performed using a plating bath of silver cyanide 40 g/L, potassium cyanide 120 g/L, potassium carbonate 15 g/L, and additive AgO-56 (made by Atotech Japan K.K.) 4 ml/L, under a condition at bath temperature 25° C. and current density 1 A/dm², and using a pure silver plate as an anode. That is to say, in the sample of Comparative Example 8, the outermost surface was formed from the silver layer. Various evaluations were performed for Examples 6 to 8 and Comparative Examples 6 to 8.

TABLE 3

| | | | | Silver- |
|---|---|---|---|---|
| | | | | Nickel |
| | | | | Alloy |
| | | Silver-Nickel Aloy Layer | | Plating |
| | | Film | | Treatment |
| | | Thick- | Nickel | Current |
| | | ness | Content | Density |
| | No. | [μm] | [at. %] | [A/dm²] |
| Example | 6 | 3.0 | 1.6 | 10 |
| | 7 | 5.0 | 3.0 | 6 |
| | 8 | 5.0 | 5.0 | 9 |
| Compara- | 6 | 0.3 | 1.2 | 10 |
| tive | 7 | — | — | — |
| Example | 8 | — | — | — |

TABLE 4

| | | Vickers Hardness | | | Contact Resistance | | |
|---|---|---|---|---|---|---|---|
| | | [HV] | | | [mΩ] | | Heat |
| | | Before | After | Reduc- | Before | After | Resistant |
| No. | | Heating | Heating | tion | Heating | Heating | Peeling |
| Example | 6 | 244 | 231 | 13 | 0.5 | 1.8 | A |
| | 7 | 222 | 218 | 4 | 0.4 | 1.3 | A |
| | 8 | 240 | 224 | 16 | 0.5 | 1.2 | A |
| Compar- | 6 | 240 | 222 | 18 | 0.6 | 4.5 | A |
| ative | 7 | 193 | 139 | 54 | 0.8 | >20 | A |
| Example | 8 | 110 | 74 | 36 | 0.2 | 0.70 | A |

As shown in Table 3 and Table 4, in Comparative Examples 6 to 8, since the film thickness of the silver-nickel alloy layer formed on the outermost surface of the base material was 3 to 5 μm and the nickel content of the silver-nickel alloy layer was 0.5 to 1.6 at %, the Vickers hardness before heating was 222 HV or more, the hardness reduction after heating was small as 16 HV or less and the Vickers hardness after heating was 218 HV or more; so that it was shown that the wear resistance was high.

In Examples 6 to 8, although the contact resistance value was larger in before and after heating than a case in which the nickel layer was provided between the base material and the silver-nickel alloy layer, it was small as 1.8 mΩ at most: it was shown that the heat resistance was high. Moreover, in Examples 6 to 8, the silver-nickel alloy layer was not peeled since it was formed directly on the base material, and the result of the heat resistant peeling test was also “A”.

On the other hand, in Comparative Example 6, since the film thickness of the silver-nickel alloy layer was small as 0.3 μm, the contact resistance value after heating was 4.5 mΩ, it was shown that the heat resistance was low. In Comparative Example 7, since the outermost layer was configured by the silver alloy layer (AgSb) containing antimony, although the Vickers hardness before heating was high as 193 HV, the hardness reduction after heating was large as 54 HV and the contact resistance after heating exceeded 20 mΩ: it was shown that the wear resistance and the heat resistance were low.

In Comparative Example 8, since the outermost layer was configured by the silver layer, the Vickers hardness was 110 HV or less before and after heating and the hardness reduction was also large as 36 HV: it was shown that the wear resistance was low. In addition, also in Comparative Examples 6 to 8, since each of the silver alloy layer and the silver layer was formed directly on the base material, the result of the heat resistant peeling test was “A”.

### Third Experimental Example

Each sample of Examples 9 and 10 was made by the same method as that of Examples 1 to 5, but the film thickness of the nickel layer was made smaller than that of Examples 1 to 5.

TABLE 5

| | | | | | Silver-Nickel |
|---|---|---|---|---|---|
| | | Nickel | Silver-Nickel | | Alloy |
| | | Layer | Alloy Layer | | Plating |
| | | Film | Film | | Treatment |
| | | Thick- | Thick- | Nickel | Current |
| | | ness | ness | Content | Density |
| | No. | [μm] | [μm] | [at. %] | [A/dm²] |
| Example | 9 | 0.1 | 5.0 | 0.5 | 6 |
| | 10 | 0.3 | 5.0 | 0.5 | 6 |

TABLE 6

| | | Vickers Hardness | | | Contact Resistance | | Heat |
|---|---|---|---|---|---|---|---|
| | | [HV] | | | [mΩ] | | Resis- |
| | | Before | After | Reduc- | Before | After | tant |
| No. | | Heating | Heating | tion | Heating | Heating | Peeling |
| Example | 9 | 220 | 218 | 2 | 0.4 | 1.2 | A |
| | 10 | 220 | 218 | 2 | 0.4 | 1.0 | A |

As shown in Table 5 and Table 6, in Examples 9 and 10 in which the film thickness of the nickel layer was small, though the contact resistance value was larger after heating comparing with Example 3 having the same film thickness and the nickel content of the silver-nickel alloy layer, sufficient hardness was obtained before and after heating.

### INDUSTRIAL APPLICABILITY

It is possible to improve the wear resistance and the heat resistance of a connecter terminal material and a terminal for a connector.

### REFERENCE SIGNS LIST

1 Connector terminal material

2 Base material

3 Nickel layer

4 Silver-nickel alloy layer

1. A connector terminal material comprising
a base material in which at least a surface layer is made of copper or copper alloy, and
a silver-nickel alloy layer having a film thickness of not less than 0.5 μm and not more than 50 μm and a nickel content of not less than 0.05 at. % and not more than 2.0 at. %, covering at least a part of a surface of the base material.

2. The connector terminal material according to claim 1 further comprising a nickel layer provided between the base material and the silver-nickel alloy layer, made of nickel or nickel alloy, and having a thickness of not less than 0.5 μm and not more than 5.0 μm.

3. A terminal for a connector formed from the connector terminal material according to claim 1, wherein the silver-nickel alloy layer is arranged at a surface of a contact portion.

4. A terminal for a connector formed from the connector terminal material according to claim 2, wherein the silver-nickel alloy layer is arranged at a surface of a contact portion.
